(19) United States
(12) Patent Application Publication
(10) Pub. No.: US 2012/0238664 A1
(43) Pub. Date: Sep. 20, 2012

(54) Thermoplastic Polymer Blends Comprising Crosslinked Polar Olefin Polymers in a Thermoplastic Polyurethane Matrix

(76) Inventors: Wilson Xiao Wei Yan, Shanghai (CN); Given Jing Chen, Shanghai (CN); Tong Wu, Shanghai (CN); Lotus Hua Huang, Shanghai (CN); David Hong Fei Guo, Pudong (CN); Jeffrey M. Cogen, Flemington, NJ (US); Will Wei Chao Gu, Shanghai (CN)

(21) Appl. No.: 13/512,718

(22) PCT Filed: Dec. 11, 2009
(86) PCT No.: PCT/CN09/75513

§ 371 Date: May 30, 2012

(51) Int. Cl. C08L 75/04; C08K 5/524

(52) U.S. Cl. 523/179

(57) ABSTRACT

Polymer blends comprising a first phase comprising a thermoplastic polyurethane matrix and a second phase comprising a crosslinked polar olefin polymer are provided. The first phase is a continuous phase and the second phase can be co-continuous with the first phase, or dispersed as a non-continuous phase in the first phase. The first phase further comprises a metal hydroxide flame retardant and an organic flame retardant. The second phase further includes a metal hydroxide which is coupled to the olefin polymer via a silane coupling agent.

### FIELD OF THE INVENTION

This invention relates to thermoplastic blends comprising a discontinuous or co-continuous phase comprising a crosslinked polar olefin polymer in a continuous thermoplastic polyurethane matrix, and further relates to articles made from the blends and methods for making the thermoplastic blends.

### BACKGROUND OF THE INVENTION

Thermoplastic polyurethane (TPU) based halogen-free flame retardant (HFFR) product packages are employed for wire insulation/cable jackets for personal electronics to replace halogen containing products. The TPU based products can provide superior flame retardant performance and mechanical properties. Furthermore, TPU based flame retardant polymers can fulfill heat deformation testing (UL-1581) requirements. However, key disadvantages for this product family include high cost, insulation resistance (IR) failure, poor smoke density and high material density.

### BRIEF SUMMARY OF THE INVENTION

One aspect of the invention provides polymer blends comprising a continuous phase comprising a thermoplastic polyurethane, a metal hydroxide and at least one organic flame retardant and a dispersed or co-continuous phase dispersed in the continuous phase or co-continuous with the continuous phase and comprising a crosslinked polar olefin polymer and the metal hydroxide, wherein the polar olefin polymer is coupled to the metal hydroxide via a silane coupling agent. In some embodiments, the polar olefin polymer is an ethylene vinyl acetate polymer. In some embodiments, the continuous phase further comprises an epoxidized novolac resin. In some embodiments, the metal hydroxide is homogenously dispersed through the continuous phase and the dispersed or co-continuous phase. In some embodiments, the crosslinked polar olefin polymer is a peroxide crosslinked polar olefin polymer.

The blends can comprise, for example, 40 to 80 weight percent thermoplastic polyurethane, based on the total weight of polymer components of the blend, 20 to 60 weight percent polar olefin polymer, based on the total weight of the polymer components of the blend, and 40 to 60 weight percent metal hydroxide, based on the total weight of the blend.

Articles, including coated cables and wires, comprising the blends are also provided.

Another aspect of the invention provides methods of making a polymer blend, the methods comprising mixing a thermoplastic polyurethane polymer, a metal hydroxide, and an organic flame retardant to form a first resin composition, mixing a polar olefin polymer, the metal hydroxide, a silane coupling agent and a peroxide crosslinking agent at a temperature above the melting temperature of the polar olefin polymer, but below the decomposition temperature of the peroxide coupling agent to form a second resin composition, and compounding the first resin composition and the second resin composition at a temperature at which the peroxide crosslinking agent decomposes and crosslinks the polar olefin polymer with continuous mixing to form a dispersed or co-continuous phase comprising the crosslinked polar olefin polymer and the metal hydroxide in a continuous phase comprising the thermoplastic polyurethane and the metal hydroxide.

In some embodiments of the methods, the polar olefin polymer is an ethylene vinyl acetate polymer and the peroxide crosslinking agent has a decomposition temperature of at least 140° C. In some embodiments, the methods further comprise adding an epoxidized novolac resin to the first resin composition.

### BRIEF DESCRIPTION OF THE DRAWINGS

FIG. 1 shows torque curves obtained from the compounding process for inventive examples 12, 14 and 15.

### DETAILED DESCRIPTION

One aspect of the invention provides a polymer blend comprising a first phase comprising a thermoplastic polyurethane matrix and a second phase comprising a crosslinked polar olefin polymer. The first phase is a continuous phase and the second phase can be co-continuous with the first phase, or dispersed as a non-continuous phase in the first phase. The first phase further comprises a metal hydroxide flame retardant and an organic flame retardant. The second phase further includes a metal hydroxide which is coupled to the olefin polymer via a silane coupling agent. The blends may also be referred to as compositions, where “composition”, “blend” and like terms mean a mixture or blend of two or more components.

The polymer blends exhibit one or more of resistance to heat deformation, flame retardance and good tensile strength and elongation at break. Other advantageous features of the polymer blends, relative to TPU, can include better cost effectiveness, lower total material density, a reduction in smoke density, improved insulation resistance, and improved material processability.

The polymer blends find applications in electrical wire insulation and jacketing, AC plug and SR converter connectors, and various other articles, including watch straps, handles, grips, soft touch articles and buttons, automotive applications, weather stripping, glass run channels, interior panels, body sealants, gaskets, window sealants and extruded profiles.

The term “polymer” which is use throughout this disclosure means a polymeric compound prepared by polymerizing monomers, whether of the same or a different type. The generic term polymer thus embraces the term homopolymer, usually employed to refer to polymers prepared from only one type of monomer, and the term interpolymer. It also embraces all forms of interpolymers, e.g., random, block, homogeneous, heterogeneous, etc.

### Continuous Phase

The continuous phase of the present blends includes at least one thermoplastic polyurethane, at least one metal hydroxide flame retardant and at least one organic flame retardant.

### Thermoplastic Polyurethanes:

A “thermoplastic polyurethane” (or “TPU”), as used herein, refers to the reaction product of a di-isocyanate, one or more polymeric diol(s), and optionally one or more difunctional chain extender(s). The TPU may be prepared by the prepolymer, quasi-prepolymer, or one-shot methods. The di-isocyanate forms a hard segment in the TPU and may be an aromatic, an aliphatic, and a cycloaliphatic di-isocyanate and combinations of two or more of these compounds. A nonlimiting example of a structural unit derived from di-isocyanate (OCN—R—NCO) is represented by formula (I) below:

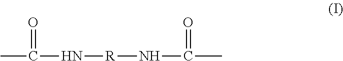

in which R is an alkylene, cycloalkylene, or arylene group. Representative examples of these diisocyanates can be found in U.S. Pat. Nos. 4,385,133, 4,522,975 and 5,167,899. Nonlimiting examples of suitable diisocyanates include 4,4′-di-isocyanatodiphenyl-methane, p-phenylene di-isocyanate, 1,3-bis(isocyanatomethyl)-cyclohexane, 1,4-di-isocyanato-cyclohexane, hexamethylene di-isocyanate, 1,5-naphthalene di-isocyanate, 3,3′-dimethyl-4,4′-biphenyl di-isocyanate, 4,4′-di-isocyanato-dicyclohexylmethane, and 2,4-toluene di-isocyanate.

The polymeric diol forms soft segments in the resulting TPU. The polymeric diol can have a molecular weight (number average) in the range, for example, from 200 to 10,000 g/mole. More than one polymeric diol can be employed. Nonlimiting examples of suitable polymeric diols include polyether diols (yielding a “polyether TPU”); polyester diols (yielding a “polyester TPU”); hydroxy-terminated polycarbonates (yielding a “polycarbonate TPU”); hydroxy-terminated polybutadienes; hydroxy-terminated polybutadiene-acrylonitrile copolymers; hydroxy-terminated copolymers of dialkyl siloxane and alkylene oxides, such as ethylene oxide, propylene oxide; natural oil diols, and any combination thereof. One or more of the foregoing polymeric diols may be mixed with an amine-terminated polyether and/or an amino-terminated polybutadiene-acrylonitrile copolymer

The difunctional chain extender can be aliphatic straight and branched chain diols having from 2 to 10 carbon atoms, inclusive, in the chain. Illustrative of such diols are ethylene glycol, 1,3-propanediol, 1,4-butanediol, 1,5-pentanediol, 1,6-hexanediol, neopentyl glycol, and the like; 1,4-cyclohexanedimethanol; hydroquinonebis-(hydroxyethyl)ether; cyclohexylenediols (1,4-, 1,3-, and 1,2-isomers), isopropylidenebis(cyclohexanols); diethylene glycol, dipropylene glycol, ethanolamine, N-methyl-diethanolamine, and the like; and mixtures of any of the above. As noted previously, in some cases, minor proportions (less than about 20 equivalent percent) of the difunctional extender may be replaced by trifunctional extenders, without detracting from the thermoplasticity of the resulting TPU; illustrative of such extenders are glycerol, trimethylolpropane, and the like.

The chain extender is incorporated into the polyurethane in amounts determined by the selection of the specific reactant components, the desired amounts of the hard and soft segments, and the index sufficient to provide good mechanical properties, such as modulus and tear strength. The polyurethane compositions can contain, for example, from 2 to 25, preferably from 3 to 20 and more preferably from 4 to 18, wt. % of the chain extender component.

Optionally, small amounts of monohydroxyl functional or monoamino functional compounds, often termed “chain stoppers,” may be used to control molecular weight. Illustrative of such chain stoppers are the propanols, butanols, pentanols, and hexanols. When used, chain stoppers are typically present in minor amounts from 0.1 to 2 weight percent of the entire reaction mixture leading to the polyurethane composition.

The equivalent proportions of polymeric diol to said extender can vary considerably depending on the desired hardness for the TPU product. Generally speaking, the equivalent proportions fall within the respective range of from about 1:1 to about 1:20, preferably from about 1:2 to about 1:10. At the same time the overall ratio of isocyanate equivalents to equivalents of active hydrogen containing materials is within the range of 0.90:1 to 1.10:1, and preferably, 0.95:1 to 1.05:1.

Nonlimiting examples of suitable TPUs include the PELLETHANE™, ESTANE™, TECOFLEX™, TECOPHILIC™, TECOTHANE™, and TECOPLAST™ thermoplastic polyurethanes all available from the Lubrizol Corporation; ELASTOLLAN™ thermoplastic polyurethanes and other thermoplastic polyurethanes available from BASF; and additional thermoplastic polyurethane materials available from Bayer, Huntsman, Merquinsa and other suppliers.

The polyurethane component of the compatibilized blends used in the practice of the invention may contain a combination of two or more TPUs as described above.

The TPUs are typically used in amounts ranging from 20 to 95 wt. % based on the weight of the TPU and olefin polymer in the blend. This includes embodiments in which TPUs are used in amounts ranging from 40 to 70 wt. % based on the weight of the TPU and olefin polymer in the blend.

### Metal Hydroxides:

The metal hydroxides in the present compositions impart flame retardant properties to the compositions. Suitable examples include, but are not limited to, aluminum trihydroxide (also known as ATH or aluminum trihydrate) and magnesium hydroxide (also known as magnesium dihydroxide). Other examples include calcium hydroxide, basic calcium carbonate, basic magnesium carbonate, hydrotalcite, huntite, and hydromagnesite. The metal hydroxide may be naturally occurring or synthetic.

The metal hydroxides are typically used in amounts of at least 25 wt. % based on the total weight of the polymer blend. This includes embodiments in which metal hydroxides are used in amounts of 30 to 70 wt. % based on the total weight of the polymer blend and further includes embodiments in which the metal hydroxides are used in amounts of 40 to 60 wt. % based on the total weight of the polymer blend. This includes any metal hydroxides in the dispersed or co-continuous phase, as described below.

### Organic Flame Retardants:

The first phase of the blend further includes at least one organic flame retardant. The flame retardants and the blends into which they are incorporated are desirably halogen-free. “Halogen-free” and like terms mean that the polymer blends are without or substantially without halogen content, i.e., contain less than 2000 mg/kg of halogen as measured by ion chromatography (IC) or a similar analytical method. Halogen content of less than this amount is considered inconsequential to the efficacy of the blend as, for example, a wire or cable covering.

Organic flame retardants include organic phosphates. Specific examples of organic flame retardants include phosphorus- or nitrogen-based flame retardants. The organic flame retardants can be intumescent flame retardants. An “intumescent flame retardant” is a flame retardant that yields a foamed char formed on a surface of a polymeric material during fire exposure. Phosphorus-based and nitrogen-based intumescent flame retardants that can be used in the practice of this invention include, but are not limited to, organic phosphonic acids, phosphonates, phosphinates, phosphonites, phosphinites, phosphine oxides, phosphines, phosphites or phosphates, phosphorus ester amides, phosphoric acid amides, phosphonic acid amides, phosphinic acid amides, and melamine and melamine derivatives, including melamine polyphosphate, melamine pyrophosphate and melamine cyanurate and mixtures of two or more of these materials. Examples include phenylbisdodecyl phosphate, phenylbisneopentyl phosphate, phenyl ethylene hydrogen phosphate, phenyl-bis-3,5,5′-trimethylhexyl phosphate), ethyldiphenyl phosphate, 2-ethylhexyl di(p-tolyl)phosphate, diphenyl hydrogen phosphate, bis(2-ethyl-hexyl)p-tolylphosphate, tritolyl phosphate, bis(2-ethylhexyl)-phenyl phosphate, tri(nonylphenyl)phosphate, phenylmethyl hydrogen phosphate, di(dodecyl)p-tolyl phosphate, tricresyl phosphate, triphenyl phosphate, triphenyl phosphate, dibutylphenyl phosphate, 2-chloroethyldiphenyl phosphate, p-tolyl bis(2,5,5′-trimethylhexyl)phosphate, 2-ethylhexyldiphenyl phosphate, and diphenyl hydrogen phosphate. Phosphoric acid esters of the type described in U.S. Pat. No. 6,404,971 are examples of phosphorus-based flame retardants. Ammonium polyphosphate is another example. The ammonium polyphosphate is often used with flame retardant co-additives, such as melamine derivatives. Additional co-additives, such as hydroxyl sources, can also be included to contribute to the intumescent flame retardant char forming mechanism. Budenheim and Adeka sell intumescent material blends such as Budenheim Budit™ 3167 (based on ammonium polyphosphate and co-additives) and Adeka FP-2100J (based on piperazine polyphosphate and co-additives).

Resorcinol diphosphate and bisphenol A polyphosphate are two examples of organic flame retardants that are well-suited for use in the present polymer blends.

The organic flame retardants are typically used in amounts ranging from 5 to 20 wt. %, based on the weight of the polymer blend. This includes embodiments in which organic flame retardants are present in amounts ranging from 12 to 15 wt. % based on the weight of the polymer blend.

### Epoxidized Novolac Resins:

The first phase of the present blends can optionally include one or more char forming agents to prevent or minimize dripping during combustion. For example, some embodiments of the compositions include an epoxidized novolac resin as a char forming agent. An “epoxidized novolac resin,” is the reaction product of epichlorohydrin and phenol novolac polymer in an organic solvent. Nonlimiting examples of suitable organic solvents include acetone, methyl ethyl ketone, methyl amyl ketone, and xylene. The epoxidized novolac resin may be a liquid, a semi-solid, a solid, and combinations thereof.

The epoxidized novolac resins are typically used in amounts ranging from 0.1 to 5 wt. % based on the total weight of the polymer blend. This includes embodiments in which the epoxidized novolac resins are used in amounts ranging from 1 to 3 wt. % based on the total weight of the polymer blend and further includes embodiments in which the epoxidized novolac resins are used in amounts ranging from 1.5 to 2.5 wt. % based on the total weight of the polymer blend.

### Dispersed or Co-Continuous Phase

The dispersed, or co-continuous, phase of the present polymer blends includes at least one crosslinked polar olefin polymer and at least one metal hydroxide flame retardant that is coupled to the polar olefin polymer via a silane coupling agent.

### Polar Olefin Polymers:

“Olefin polymer”, “olefinic polymer”, “olefinic interpolymer”, “polyolefin”, “olefin-based polymer” and like terms mean a polymer containing, in polymerized form, a majority weight percent of an olefin, for example ethylene or propylene, based on the total weight of the polymer. Thermoplastic polyolefins include both olefin homopolymers and interpolymers. “Interpolymer” means a polymer prepared by the polymerization of at least two different monomers. The interpolymers can be random, block, homogeneous, heterogeneous, etc. This generic term includes copolymers, usually employed to refer to polymers prepared from two different monomers, and polymers prepared from more than two different monomers, e.g., terpolymers, tetrapolymers, etc.

A “polar olefin polymer,” is an olefin polymer containing one or more polar groups (sometimes referred to as polar functionalities). A “polar group,” as used herein, is any group that imparts a bond dipole moment to an otherwise essentially nonpolar olefin molecule. Exemplary polar groups include carbonyls, carboxylic acid groups, carboxylic acid anhydrate groups, carboxylic ester groups, epoxy groups, sulfonyl groups, nitrile groups, amide groups, silane groups and the like. These groups can be introduced into the olefin-based polymer either through grafting or copolymerization. Nonlimiting examples of polar olefin-based polymers include ethylene/acrylic acid (EAA), ethylene/methacrylic acid (EMA), ethylene/acrylate or methacrylate, ethylene/vinyl acetate (EVA), poly(ethylene-co-vinyltrimethoxysilane) copolymer, maleic anhydrate- or silane-grafted olefin polymers, poly(tetrafluoroethylene-alt-ethylene) (ETFE), poly(tetrafluoroethylene-co-hexafluoro-propylene) (FEP), poly(ethylene-co-tetrafluoroethylene-co-hexafluoropropylene (EFEP), poly(vinylidene fluoride) (PVDF), poly(vinyl fluoride) (PVF), and the like. Preferred polar olefin polymers include DuPont ELVAX™ ethylene vinyl acetate (EVA) resins, AMPLIFY™ ethylene ethyl acrylate (EEA) copolymer from The Dow Chemical Company, PRIIVIACOR™ ethylene/acrylic acid copolymers from The Dow Chemical Company, and SI-LINK™ poly(ethylene-co-vinyltrimethoxysilane) copolymer from The Dow Chemical Company.

EVA is a preferred polar olefin polymer. This includes copolymers of EVA with one or more comonomers selected from C₁ to C₆ alkyl acrylates, C₁ to C₆ alkyl methacrylates, acrylic acid and methacrylic acid. The EVA polymers can have, for example, a vinyl acetate content ranging from 10 wt. % to 90 wt. %. This includes embodiments in which the EVA polymer has a vinyl acetate content ranging from 20 wt. % to 40 wt. %.

The polar olefin polymers are typically used in amounts ranging from 5 to 80 wt. % based on the weight of the TPU and olefin polymer in the polymer blend. This includes embodiments in which olefin polymers are used in amounts ranging from 30 to 60 wt. % based on the weight of the TPU and olefin polymer in the polymer blend.

### Crosslinking Agents:

The olefin polymers of the second phase are crosslinked via a crosslinking agent. Suitable crosslinking agents include free radical initiators, preferably organic peroxides. Suitable peroxides include aromatic diacyl peroxides; aliphatic diacyl peroxides; dibasic acid peroxides; ketone peroxides; alkyl peroxyesters; alkyl hydroperoxides. Examples of useful organic peroxides include 1,1-di-t-butyl peroxy-3,3,5-trimethylcyclohexane, dicumyl peroxide, 2,5-dimethyl-2,5-di(t-butyl peroxy)hexane, t-butyl-cumyl peroxide, di-t-butyl peroxide, 2,5-dimethyl-2,5-di-(t-butyl peroxy)hexyne, diacetylperoxide, dibenzoylperoxide, bis-2,4-dichlorobenzoyl peroxide, tert-butylperbenzoate, tert-butylcumylperoxide, 4,4,4′,4′-tetra-(t-butylperoxy)-2,2-dicyclohexylpropane, 1,4-bis-(t-butylperoxyisopropyl)-benzene; lauroyl peroxide, succinic acid peroxide, cyclohexanone peroxide, t-butyl peracetate; and butyl hydroperoxide. Additional teachings regarding organic peroxide crosslinking agents are available in the Handbook of Polymer Foams and Technology, pp. 198-204. Suitable peroxide crosslinking agents desirably have a decomposition temperature greater than 140° C.

The crosslinking agents are typically used in amounts ranging from 0.01 to 5 wt. %, based on the total weight of the polymer blend. This includes embodiments in which the crosslinking agents are present in amounts ranging from 0.05 to 5 wt. %, and further includes embodiments in which the crosslinking agents are present in amounts ranging from 0.25 to 2 wt. %, based on the weight of the polymer blend.

The polymer blends can further optionally include one or more crosslinking catalysts (also referred to as a crosslinking accelerator or crosslinking activator) for the crosslinking agents. Examples of crosslinking catalysts for peroxide crosslinking agents include triallyl isocyanurate (TAIC) and triallylcyanurate (TAC). The crosslinking catalysts are typically used in amounts ranging from 0.01 to 4 wt. %, based on the weight of the polymer blend.

### Metal Hydroxides:

The metal hydroxides of the second phase can be the same as the metal hydroxides of the first phase. In some embodiments, the metal hydroxides are homogenously dispersed throughout the first and second phases.

### Silane Coupling Agents:

The metal hydroxides of the second phase are coupled to the polar olefin polymer via a silane coupling agent. Examples of silane-based coupling agents include vinyltrimethoxyethoxysilane, oligomer-type vinyltrimethoxysilane, and vinyltriethoxysilane. The polymer blends typically include 0.5 to 5 wt. %, based on the total weight of the polymer blend. This includes embodiments in which the blends include 1 to 3 wt. % silane coupling agent, based on the total weight of the polymer blend.

### Optional Additives and Fillers

The polymer blends of this invention can, optionally, also contain additives and/or fillers. Representative additives include, but are not limited to, antioxidants, processing aids, colorants, ultraviolet stabilizers (including UV absorbers), antistatic agents, nucleating agents, slip agents, plasticizers, lubricants, viscosity control agents, tackifiers, anti-blocking agents, surfactants, extender oils, acid scavengers, and metal deactivators. These additives are typically used in a conventional manner and in conventional amounts, e.g., from 0.01 wt. % or less to 10 wt. % or more based on the total weight of the polymer blend.

Representative fillers include but are not limited to the various metal oxides, e.g., titanium dioxide; metal carbonates such as magnesium carbonate and calcium carbonate; metal sulfides and sulfates such as molybdenum disulfide and barium sulfate; metal borates such as barium borate, meta-barium borate, zinc borate and meta-zinc borate; metal anhydride such as aluminum anhydride; clay such as diatomite, kaolin and montmorillonite; huntite; celite; asbestos; ground minerals; and lithopone. These fillers are typically used a conventional manner and in conventional amounts, e.g., from 5 wt. % or less to 50 wt. % or more based on the weight of the blend.

Suitable UV light stabilizers include hindered amine light stabilizers (HALS) and UV light absorber (UVA) additives. Representative HALS that can be used in the blends include, but are not limited to, TINUVIN XT 850, TINUVIN 622, TINUVIN® 770, TINUVIN® 144, SANDUVOR® PR-31 and Chimassorb 119 FL. TINUVIN® 770 is bis-(2,2,6,6-tetramethyl-4-piperidinyl)sebacate, has a molecular weight of about 480 grams/mole, is commercially available from Ciba, Inc. (now a part of BASF), and possesses two secondary amine groups. TINUVIN® 144 is bis-(1,2,2,6,6-pentamethyl-4-piperidinyl)-2-n-butyl-2-(3,5-di-tert-butyl-4-hydroxybenzyl)malonate, has a molecular weight of about 685 grams/mole, contains tertiary amines, and is also available from Ciba. SANDUVOR® PR-31 is propanedioic acid, [(4-methoxyphenyl)-methylene]-bis-(1,2,2,6,6-pentamethyl-4-piperidinyl)ester, has a molecular weight of about 529 grams/mole, contains tertiary amines, and is available from Clariant Chemicals (India) Ltd. Chimassorb 119 FL or Chimassorb 119 is 10 wt. % of dimethyl succinate polymer with 4-hydroxy-2,2,6,6,-tetramethyl-1-piperidineethanol and 90 wt. % of N,N″-[1,2-Ethanediylbis[[[4,6-bis[butyl(1,2,2,6,6-pentamethyl-4-piperidinyl)amino]-1,3,5-traizin-2-yl]imino]-3,1-propanediyl]]bis[N′N″-dibutyl-N′N″-bis(1,2,2,6,6-pentamethyl-4-piperidinyl)]-1, is commercially available from Ciba, Inc. Representative UV absorber (UVA) additives include benzotriazole types such as Tinuvin 326 and Tinuvin 328 commercially available from Ciba, Inc. Blends of HAL's and UVA additives are also effective.

Examples of antioxidants include, but are not limited to, hindered phenols such as tetrakis[methylene(3,5-di-tert-butyl-4-hydroxyhydro-cinnamate)]methane; bis[(beta-(3,5-ditert-butyl-4-hydroxybenzyl)-methylcarboxyethyl)]sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha,alpha-dimethylbenzyl)diphenylamine, diphenyl-p-phenylenediamine, mixed di-aryl-p-phenylenediamines, and other hindered amine anti-degradants or stabilizers.

Examples of processing aids include, but are not limited to, metal salts of carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non ionic surfactants; silicone fluids and polysiloxanes.

### Blend Properties:

### Heat Deformation:

Wires coated with some embodiments of the polymer blends generally exhibit a heat deformation ratio of less than 50% at 150° C. according to UL 1581-2001. In some embodiments, the coated wires exhibit a heat deformation of no greater than 40 percent, no greater than 40 percent, no greater than 30 percent, or even no greater than 20 percent, measured at 150° C. and a 350 gram load (3.5±0.2 N) according to UL 1581.

### Flame Retardance:

Wires coated with some embodiments to of the blends pass the UL VW-1 flame rating. “VW-1” is an Underwriters' Laboratory (UL) flame rating for wire and sleeving. It denotes “Vertical Wire, Class 1”, which is the highest flame rating a wire or sleeve can be given under the UL 1441 specification. The test is performed by placing the wire or sleeve in a vertical position. A flame is set underneath it for a period of time, and then removed. The characteristics of the sleeve are then noted. The VW-1 flame test is determined in accordance with method 1080 of UL-1581.

### Tensile Strength and Elongation at Break:

The present polymer blends can be characterized by their tensile strength at break (in MPa) and elongation at break (%).

Tensile strength and elongation can be measured in accordance with the ASTM D-638 testing procedure on compression molded samples prepared according to ASTM D4703. Elongation at break, or elongation to break, is the strain on a sample when it breaks. It usually is expressed as a percent.

Some embodiments of the present polymer blends have tensile strengths at break of at least 8 MPa. This includes polymer blends having tensile strength at break of at least 10 MPa and further includes polymer blends having a tensile strength at break of at least 12 MPa.

Some embodiments of the present polymer blends have an elongation at break of at least 150%. This includes polymer blends having an elongation at break of at least 160%, further includes polymer blends having an elongation at break of at least 180% and still further includes polymer blends having an elongation at break of at least 200%.

### Compounding:

Another aspect of the invention provides methods of making a polymer blend comprising a first phase comprising a thermoplastic polyurethane matrix and a second phase comprising a crosslinked polar olefin polymer. The polymer blends can be made by crosslinking an olefin polymer to form a co-continuous or discontinuous phase in an thermoplastic polyurethane matrix. During dynamic vulcanization, the vulcanizable polar olefin polymer is dispersed into a resinous thermoplastic polyurethane and the olefin polymer is crosslinked in the presence of a crosslinking agent while continuously mixing and shearing the polymer blend. During the crosslinking of the olefin polymer, the viscosity of the olefin polymer phase increases, causing the viscosity ratio of the blend to increase. The shear stress causes the olefin polymer phase to form dispersed particles in the thermoplastic polyurethane matrix. Alternatively, if the crosslinking density of the olefin polymer phase is not sufficiently high, the olefin polymer phase can remain co-continuous with the thermoplastic polyurethane phase.

One embodiment of the methods includes mixing a thermoplastic polyurethane polymer, a metal hydroxide, an organic flame retardant, and optionally, an epoxidized novolac resin to form a first resin composition and mixing a polar olefin polymer, a metal hydroxide, a silane coupling agent and a crosslinking agent at a temperature above the melting temperature of the polar olefin polymer, but below the decomposition temperature of the peroxide crosslinking agent to form a second resin composition. The mixing can take place in a step-wise fashion or in a single step and can be carried out in a conventional tumbling device. The first and second resin compositions can then be compounded at a temperature at which the peroxide decomposes and crosslinks the polar olefin polymer with continuous mixing to form a dispersed or co-continuous phase comprising the crosslinked polar olefin polymer and the metal hydroxide in a continuous phase comprising the thermoplastic polyurethane and the metal hydroxide. The methods may additionally include mixing additives and fillers into the first and/or second resin compositions prior to, or during, compounding.

Compounding of the resin compositions and polymer blends can be effected by standard compounding equipment. Examples of compounding equipment are internal batch mixers, such as a Banbury™ or Bolling™ internal mixer. Alternatively, continuous single, or twin screw, mixers can be used, such as a Farrel™ continuous mixer, a Werner and Pfleiderer™ twin screw mixer, or a Buss™ kneading continuous extruder. The type of mixer utilized, and the operating conditions of the mixer, will affect properties of the composition such as viscosity, volume resistivity, and extruded surface smoothness. The resulting polymer blends are desirably capable of being molded and shaped into an article, such as a wire jacket, profile, sheet or pellet for further processing.

### Articles

Another aspect of the invention provides articles, such as molded or extruded articles, comprising one or more blends of present invention.

Articles include cable jackets and wire insulation. Thus, in some embodiments, the article includes a metal conductor and a coating on the metal conductor to provide an “insulated” wire capable of electrical transmission of low voltage telecommunication signals or for a wide range of electrical power transmission applications. A “metal conductor,” as used herein, is at least one metal component used to transmit either electrical power and/or electrical signals. Flexibility of wire and cables is often desired, so the metal conductor can have either a solid cross-section or preferentially can be composed of smaller wire strands that provide increased flexibility for the given overall conductor diameter. Cables are often composed of several components such as multiple insulated wires formed into an inner core, and then surrounded by a cable sheathing system providing protection and cosmetic appearance. The cable sheathing system can incorporate metallic layers such as foils or armors, and typically has a polymer layer on the surface. The one or more polymer layers incorporated into the protective/cosmetic cable sheathing are often referred to cable “jacketing”. For some cables, the sheathing is only a polymeric jacketing layer surrounding a cable core. There are also some cables having a single layer of polymer surrounding the conductors, performing both the roles of insulation and jacketing. The present polymer blends may be used as, or in, the polymeric components in a full range of wire and cable products, including power cables and both metallic and fiber optic communication applications. Use includes both direct contact and indirect contact between the coating and the metal conductor. “Direct contact” is a configuration whereby the coating immediately contacts the metal conductor, with no intervening layer(s) and/or no intervening material(s) located between the coating and the metal conductor. “Indirect contact” is a configuration whereby an intervening layer(s) and/or an intervening material(s) is located between the metal conductor and the coating. The coating may wholly or partially cover or otherwise surround or encase the metal conductor. The coating may be the sole component surrounding the metal conductor. Alternatively, the coating may be one layer of a multilayer jacket or sheath encasing the metal conductor.

Nonlimiting examples of suitable coated metal conductors include wiring for consumer electronics, a power cable, a power charger wire for cell phones and/or computers, computer data cords, power cords, appliance wiring material, and consumer electronic accessory cords.

A cable containing an insulation layer comprising a polymer blend of this invention can be prepared with various types of extruders, e.g., single or twin screw types. These blends should have extrusion capability on any equipment suitable for thermoplastic polymer extrusion. The most common fabrication equipment for wire and cable products is a single screw plasticating extruder. A description of a conventional single screw extruder can be found in U.S. Pat. No. 4,857,600. An example of co-extrusion and an extruder therefore can be found in U.S. Pat. No. 5,575,965. A typical extruder has a hopper at its upstream end and a die at its downstream end. Granules of the polymer blend feed through a hopper into the extruder barrel, which contains a screw with a helical flight. The length to diameter ratio of extruder barrel and screw is typically in the range of about 15:1 to about 30:1. At the downstream end, between the end of the screw and the die, there is typically a screen pack supported by a breaker plate used to filter any large particulate contaminates from the polymer melt. The screw portion of the extruder is typically divided up into three sections, the solids feed section, the compression or melting section, and the metering or pumping section. The granules of the polymer blend are conveyed through the feed zone into the compression zone, where the depth of the screw channel is reduced to compact the material, and the thermoplastic polymer is fluxed by a combination of heat input from the extruder barrel, and frictional shear heat generated by the screw. Most extruders have multiple barrel heating zones (more than two) along the barrel axis running from upstream to downstream. Each heating zone typically has a separate heater and heat controller to allow a temperature profile to be established along the length of the barrel. There are additional heating zones in the crosshead and die assembles, where the pressure generated by the extruder screw causes the melt to flow and be shaped into the wire and cable product which typically moves perpendicular to the extruder barrel. After shaping, thermoplastic extrusion lines typically have a water trough to cool and solidify the polymer into the final wire or cable product, and then have reel take-up systems to collect long lengths of this product. There are many variations of the wire and cable fabrication process, for example, there are alternate types of screw designs such as barrier mixer or other types, and alternate processing equipment such as a polymer gear pump to generate the discharge pressure.

The following examples illustrate various embodiments of this invention. All parts and percentages are by weight unless otherwise indicated.

### SPECIFIC EMBODIMENTS

The following examples illustrate embodiments of methods for making thermoplastic polymer blends in accordance with the present invention.

### Materials

PELLETHANE™ 2135-90 AE polytetramethylene glycol ether thermoplastic polyurethane (TPU) (obtained from Lubrizol Advanced Materials) and ELVAX™ 265 ethylene-vinyl-acetate copolymer (DuPont de Nemours & Co, vinyl acetate (VA) content 28%) are used in these examples. The selected peroxide is 2,5-bis(tert-butylperoxy)-2,5-dimethylhexane (Luperox-101, obtained from ALDRICH) with a purity of 90% and density of 0.877 g·cm⁻³. Vinyltrimethoxysilane (VTMS, AR grade, obtained from ALDRICH) with a purity of 97% and density of 0.971 g·cm⁻³ is used as received. The VTMS is provided in the liquid state and is characterized by a very slow decomposition under 140° C. The L-101 peroxide has a half life time of 28 s at a processing temperature of 190° C. Resorcinol bis(diphenyl phosphate) (RDP) is obtained from Supresta, with grade name Fyrolflex®RDP. The epoxidized novolac resin is solvent free DEN 438 with an epoxide equivalent weight (EEW) of 176-181, obtained from The Dow Chemical Company. Aluminum trihydrate (ATH) with a low bulk density of 0.2-0.5 g/cm³ is obtained from SHOWA Chemical, Japan.

### Methods

Prior to mixing the components and compounding the polymer blend, the TPU is pre-dried at 90° C. under vacuum for at least 6 hour, the EVA is pre-dried at 40° C. under vacuum for at least 6 hours (this can also be done at, for example, ambient conditions), and the metal hydroxide is pre-dried at 90° C. under vacuum for at least 8 hours. If necessary or desirable, the dried polymers can be stored under moisture-free conditions prior to compounding.

The dried EVA pellets are soaked with the prescribed amount of liquid silane and vinylsilane under ambient condition for 20 minutes with the aid of a twin roller. The soaked EVA pellets are then compounded with ATH at a temperature which will not lead to significant decomposition of the peroxide crosslinking agent. This provides a polar olefin polymer resin composition. Alternatively, the preparation of the polar olefin polymer resin composition can be carried out in a single step by compounding dried EVA with the vinyl silane and the peroxide, followed by loading with the ATH. Other compounding temperatures can be used. Generally, the temperature should be in the range from the melting temperature of the EVA to 140° C., the temperature at which decomposition of the peroxide becomes significant. For example, compounding can be carried out at temperatures in the range of 100 to 120° C.

The dried TPU is compounded with ATH, RDP and the epoxidized novolac to provide a TPU resin composition. If necessary or desirable, one or both of the resin compositions can be stored under moisture-free conditions prior to blending. In these examples compounding of the TPU, ATH, RDP and epoxidized novolac resin is carried out at temperatures in the range of 160° C. to 220° C. (e.g., 180° C. to 200° C.).

The TPU resin composition is then blended with the polar olefin polymer resin composition at a temperature leading to the significant decomposition of the peroxide crosslinking agent. The blending time is desirably more than 4 times the half-decomposition period of the peroxide at the blending temperature (e.g., up to 30 minutes). For example blending can be carried out for 6 to 20 minutes. In these examples compounding of the two resin compositions is carried out at a temperatures in the range of 160° C. to 220° C. (e.g., 180° C. to 200° C.) at a shear speed in the range of 50 to 150 rpm (e.g., 60 to 100 rpm).

All of the compounding is carried out in a lab-scale Haake Mixer (Haake Polylab OS RheoDrive 7, from Thermo Scientific) in a closed mixing room.

### Characterization

The polymer blends are pressed into plaques with a thickness around 1.5 mm at a presser temperature of 180-185° C., and then used for the testing procedures described immediately below.

Heat Deformation:

Heat deformation testing is carried out in accordance with UL 1581-2001.

Tensile Testing:

The tensile strength at break and the elongation at break are measured according to ASTM D638. The tensile testing is performed on a INSTRON 5565 Tensile Tester.

Flame Retardance:

The flame retardance of the polymer blends was measured according to the VW-1 standard, as previously described. In the present experiments, simulated VW-1 testing is conducted in a UL-94 chamber. The test specimens have a dimension of 200*2.7*1.9 mm. The specimen is hanged on a clamp, with its longitudinal axis vertical by applying a 50 g load on to its lower end. A paper flag (2*0.5 cm) is placed on the top of the wire. The distance between the flame bottom (highest point of the burner oracle) and the bottom of flag is 18 cm. The flame is applied continuously for 45 sec. After flame time (AFT), uncharred wire length (UCL) and uncharred flag area percentage (flag uncharred) are recorded during and after combustion. Five or six specimen are tested for each sample. Any of the following phenomenons will result in a rating of “not pass”: (1) the cotton under the specimen is ignited; (2) the flag is burned out; or (3) dripping with flame is observed.

### Inventive Examples 1-4

### Preparation of Resin-A Comprising TPU, ATH, RDP and Epoxidized Novolac

Four samples are prepared according to the formulation given in Table 1. In these examples, TPU and ATH are pre-dried at 90° C. under vacuum for 8 hours. Compounding is conducted on a Haake Mixer with a rotator speed of 60 rpm and a set temperature of 180° C. Generally the compounding lasts for 6 min after feeding all the components into the mixer.

TABLE 1
Preparation of Resin-A comprising TPU,
ATH, RDP and epoxidized novolac.

| | Inventive | Inventive | Inventive | Inventive |
|---|---|---|---|---|
| Sample ID | example 1 | example 2 | example 3 | example 4 |
| TPU | 43% | 38% | 38% | 45% |
| ATH | 40% | 45% | 40% | 40% |
| RDP | 15% | 15% | 20% | 15% |
| Epoxidized | 2% | 2% | 2% | |
| novolac resin | | | | |

The percentages in the table are weight percents based on the total weight of all components in the final polymer blend.

### Inventive Examples 5-8

### Preparation of Resin-B Comprising EVA, ATH, Vinylsilane and Peroxide

Four samples are prepared according to the formulation given in Table 2. In these examples, EVA is pre-dried at 40° C. under vacuum for 8 hours. ATH is pre-dried at 90° C. under vacuum for 8 hours. Compounding is conducted on a Haake Mixer with a rotator speed of 60 rpm and a set temperature of 110° C. Generally the compounding lasts for 6 min after feeding all the components into the mixer.

TABLE 2
Preparation of Resin-B comprising
EVA, ATH, vinylsilane and peroxide.

| | Inventive | Inventive | Inventive | Inventive |
|---|---|---|---|---|
| Sample ID | example 5 | example 6 | example 7 | example 8 |
| EVA | 51% | 43% | 43% | 41% |
| ATH | 47.25% | 55.25% | 55% | 57% |
| Vinyltrimethoxysilane | 1.5% | 1.5% | 1.5% | 1.5% |
| Luperox 101 | 0.25% | 0.25% | 0.5% | 0.5% |

The percentages in the table are weight percents based on the total weight of all components in the final polymer blend.

### Inventive Examples 9-16

### Compounding Resin-A with Resin-B at Different Weight Ratios and the Final Material Properties

In inventive examples 9-15, Resin-A from inventive example 1 is compounded with Resin-B from inventive example 5 at a set temperature of 180° C. in the Haake Mixer with a rotator speed of 60 rpm for all the runs. Generally compounding lasts for 6-15 minutes depending on the specific ratio between Resin-A and Resin-B. In inventive example 16, Resin A from inventive example 4 is used rather than Resin A from inventive example 1.

Heat deformation at 150° C., tensile and in-house mimic VW-1 testing are conducted to determine the material properties with reference to the related testing standards. The results are summarized in Table 3. As illustrated by the testing results, the flame retardant performance of prepared samples changes from a robust pass to a marginal pass by incorporating as high as 20% of Resin-B into polymer blend. In the case of eliminating epoxidized novolac from Resin-A, the blend did not pass the mimic VW-1 testing as illustrated by the results of inventive example 16. All the samples give a tensile stress higher than 8.3 MPa and elongation higher than 150%, based on the average values.

TABLE 3
Compounding Resin-A with Resin-B at different weight ratios and the
final material properties.

| | Inventive | Inventive | Inventive | Inventive | Inventive | Inventive | Inventive | Inventive |
|---|---|---|---|---|---|---|---|---|
| | example | example | example | example | example | example | example | example |
| Sample ID | 9 | 10 | 11 | 12 | 13 | 14 | 15 | 16 |
| Resin-A | 95% | 90% | 85% | 80% | 70% | 60% | 40% | 80% |
| (from | | | | | | | | (Resin- |
| inventive | | | | | | | | A, from |
| example 1) | | | | | | | | inventive |
| | | | | | | | | example 4) |
| Resin-B | 5% | 10% | 15% | 20% | 30% | 40% | 60% | 20% |
| (from | | | | | | | | |
| inventive | | | | | | | | |
| example 5) | | | | | | | | |
| Heat | | 20 | 18 | 21 | 26 | 34 | 46 | 24 |
| deformation | | | | | | | | |
| at 150° C./% | | | | | | | | |
| Tensile | 9.8 | 9.9 | 10.3 | 11.6 | 10.0 | 10.5 | 10.6 | 8.3 |
| stress/MPa | | | | | | | | |
| Std dev/MPa | 0.2 | 0.6 | 0.3 | 0.2 | 0.3 | 0.04 | 0.3 | 0.2 |
| Tensile | 184 | 171 | 197 | 177 | 160 | 154 | 163 | 161 |
| elongation/% | | | | | | | | |
| Std dev/% | 7 | 18 | 14 | 12 | 12 | 4 | 25 | 24 |
| Mimic | 5/5 | 5/5 | 5/6 | 4/6 | N/A | 0/5 | 0/5 | 0/5 |
| VW-1 | | | | | | | | |
| testing | | | | | | | | |
| (Pass/Total) | | | | | | | | |

The percentages in the second row of table 3 indicate the weight ratios of Resin-A and Resin-B in the final polymer blend. The heat deformation results in table 3 are determined by averaging the testing results obtained from two sample specimens for each formulation. The term ‘Std dev’ in table 3 indicates the standard deviation for the testing results for tensile stress and elongation. Pass/Total indicates the number of samples passing the mimic VW-1 testing versus the total number of tested samples.

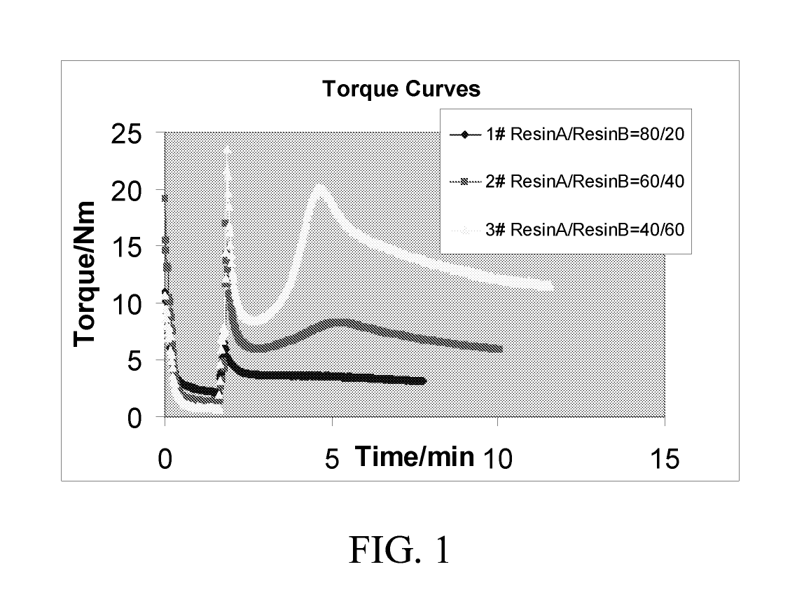

Torque curves are obtained from the compounding process for inventive examples 12, 14 and 15 (designated as curves 1, 2 and 3, respectively in FIG. 1.) The dynamic crosslinking of EVA in the presence of peroxide is indicated by the initial increase in the torque and the following decrease in the torque, indicating the dispersion of crosslinked EVA into the TPU matrix.

### Inventive Examples 17-23

### Compounding Resin-A with Resin-B at Different ATH and Peroxide Loading and the Final Material Properties

The data in table 4 illustrates the effect of changing the peroxide and ATH loadings in both Resin-A and Resin-B in the polymer blends. Increasing the ATH loading either in Resin-A or in Resin-B favors the flame retardance performance of the samples. However, increasing the ATH loading in Resin-A from 40% to 45% tends to lower both tensile stress and elongation as illustrated by the results of inventive examples 18 and 21 in the table. In contrast, increasing the ATH and peroxide loading in Resin-B to 55% or 57% appears to favor the enhancement of both tensile stress and elongation, as illustrated by inventive examples 19 and 20. Furthermore, the results from inventive examples 22 and 23 illustrate that increasing the RDP loading in Resin-A improves the FR performance of the prepared samples.

TABLE 4
Compounding Resin-A with Resin-B at different ATH and peroxide
loadings and the final polymer blend properties.

| Sample ID | 17 | 18 | 19 | 20 | 21 | 22 | 23 |
|---|---|---|---|---|---|---|---|
| Resin-A (from inventive | 80% | | 80% | 80% | | 60% | |
| example 1) | | | | | | | |
| Resin-A (from inventive | | 80% | | | 80% | | |
| example 2) | | | | | | | |
| Resin-A (from inventive | | | | | | | 60% |
| example 3) | | | | | | | |
| Resin-B (from inventive | 20% | 20% | | | | | |
| example 4) | | | | | | | |
| Resin-B (from inventive | | | 20% | | | | |
| example 5) | | | | | | | |
| Resin-B (from inventive | | | | 20% | 20% | | |
| example 6) | | | | | | | |
| Resin-B (from inventive | | | | | | 40% | 40% |
| example 7) | | | | | | | |
| Heat deformation at | 24 | 31 | 26 | 23 | 28 | 43 | 47 |
| 150° C./% | | | | | | | |
| Tensile stress/MPa | 10.5 | 9.4 | 10.9 | 10.8 | 9.9 | 12.3 | 10.7 |
| Std dev/MPa | 0.5 | 0.3 | 0.3 | 0.2 | 0.2 | 0.4 | 0.2 |
| Tensile elongation/% | 190 | 130 | 184 | 205 | 175 | 173 | 205 |
| Std dev/% | 19 | 9 | 15 | 31 | 24 | 21 | 10 |
| Mimic VW-1 testing | 4/5 | 5/5 | 4/5 | 5/5 | 5/5 | 2/6 | 3/6 |
| (Pass/Total) | | | | | | | |

The percentages in table 4 indicate the weight ratios of Resin-A and Resin-B in the final polymer blend. The heat deformation results are determined by averaging the testing results obtained from two sample specimens for each formulation. The term ‘Std dev’ in table 4 indicates the standard deviation for the testing results for tensile stress and elongation. Pass/Total indicates the number of samples passing the mimic VW-1 testing versus the total number of tested samples. For these examples, the Haake Mixer used in the compounding steps has a rotator speed fixed at 100 rpm.

### Comparative Example 1

### Composition Using TPU as Base Polymer

A halogen-free flame retardant composition based on TPU is prepared for comparison. The formulation for this comparative example is shown in Table 5 (comparative example 1). Conditions for compounding are the same as those in the inventive examples.

Dripping and melt-sag are generally observed when performing the mimic VW-1 testing while the self-extinguishing effect is obvious for this sample.

TABLE 5
Comparative polymer blends using TPU and
TPU/uncrosslinked EVA as base polymer.

| | Comparative | Comparative | Comparative |
|---|---|---|---|
| Sample ID | example 1 | example 2 | example 3 |
| TPU | 43% | 34% | 26% |
| EVA | | 9% | 17% |
| ATH | 40% | 40% | 40% |
| RDP | 15% | 15% | 15% |
| Epoxidized | 2% | 2% | 2% |
| novolac | | | |
| Heat deformation | 33 | 100 | 100 |
| at 150° C./% | | | |
| Tensile stress/MPa | 11.3 | 12 | 6.9 |
| Std dev/MPa | 0.3 | 0.3 | 0.4 |
| Tensile | 348 | 302 | 182 |
| elongation/% | 12 | 41 | 6 |
| Std dev/% | | | |
| Mimic VW-1 | 5/5 | 5/5 | 1/6 |
| testing | | | |
| (Pass/Total) | | | |

In table 5, the percentages indicate the weight percent of each component in the final polymer blend, based on the total weight of that polymer blend. The heat deformation results are determined by averaging the testing results obtained from two sample specimens for each formulation. The term ‘Std dev’ in table 5 indicates the standard deviation for the testing results for tensile stress and elongation. Pass/Total indicates the number of samples passing the mimic VW-1 testing versus the total number of tested samples.

### Comparative Examples 2-3

### Compositions Using TPU/uncrosslinked EVA as a Base Polymer

Halogen-free flame retardant compositions based on TPU/EVA in which the EVA not crosslinked are prepared for comparison. The formulations are shown in Table 5 (comparative examples 2 and 3). Conditions for compounding are the same as those in the inventive examples. In these examples, pre-dried EVA pellets are added together with TPU pellets.

The results of the heat deformation testing at 150° C. illustrate that the deformation ratio is unacceptable when adding EVA into the TPU matrix. Additionally, dripping and melt-sag are also observed for the two comparative samples when the mimic VW-1 testing is preformed.

As illustrated above, most of the inventive examples pass the minimum customer requirements of a tensile stress higher than 8.3 MPa, tensile elongation larger than 150%, heat deformation ratio less than 50% and pass the VW-1 vertical burning test.

All references to the Periodic Table of the Elements refer to the Periodic Table of the Elements published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, product and processing designs, polymers, catalysts, definitions (to the extent not inconsistent with any definitions specifically provided in this disclosure), and general knowledge in the art.

The numerical ranges in this disclosure are approximate unless otherwise indicated. Numerical ranges include all values from and including the lower and the upper values, in increments of one unit, provided that there is a separation of at least two units between any lower value and any higher value. As an example, if a compositional, physical or other property, such as, for example, tensile strength, elongation at break, etc., is from 100 to 1,000, then the intent is that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the amounts of polyolefin, TPU, metal hydroxides and additives in the composition, and the various characteristics and properties by which these components are defined.

As used with respect to a chemical compound, unless specifically indicated otherwise, the singular includes all isomeric forms and vice versa (for example, “hexane”, includes all isomers of hexane individually or collectively). The terms “compound” and “complex” are used interchangeably to refer to organic-, inorganic- and organometal compounds.

The term “or”, unless stated otherwise, refers to the listed members individually as well as in any combination.

Although the invention has been described in considerable detail through the preceding description, drawings and examples, this detail is for the purpose of illustration. One skilled in the art can make many variations and modifications without departing from the spirit and scope of the invention as described in the appended claims.

1. A polymer blend comprising:
(a) a continuous phase comprising a thermoplastic polyurethane, a metal hydroxide and at least one organic flame retardant; and
(b) a dispersed or co-continuous phase dispersed in the continuous phase or co-continuous with the continuous phase and comprising a crosslinked polar olefin polymer and the metal hydroxide, wherein the polar olefin polymer is coupled to the metal hydroxide via a silane coupling agent.

2. The blend of claim 1, in which the polar olefin polymer is an ethylene vinyl acetate polymer.

3. The blend of claim 1, in which the continuous phase further comprises an epoxidized novolac resin.

4. The blend of claim 1, in which the metal hydroxide is homogenously dispersed through the continuous phase and the dispersed or co-continuous phase.

5. The blend of claim 1 comprising 40 to 80 weight percent thermoplastic polyurethane, based on the total weight of polymer components of the blend, 20 to 60 weight percent polar olefin polymer, based on the total weight of the polymer components of the blend, and 40 to 60 weight percent metal hydroxide, based on the total weight of the blend.

6. The blend of claim 1, in which the crosslinked polar olefin polymer is a peroxide crosslinked polar olefin polymer.

7. An article comprising the blend of claim 1.

8. A method of making a polymer blend, the method comprising:
(a) mixing a thermoplastic polyurethane polymer, a metal hydroxide, and an organic flame retardant to form a first resin composition;
(b) mixing a polar olefin polymer, the metal hydroxide, a silane coupling agent and a peroxide crosslinking agent at a temperature above the melting temperature of the polar olefin polymer, but below the decomposition temperature of the peroxide coupling agent to form a second resin composition; and
(c) compounding the first resin composition and the second resin composition at a temperature at which the peroxide crosslinking agent decomposes and crosslinks the polar olefin polymer with continuous mixing to form a dispersed or co-continuous phase comprising the crosslinked polar olefin polymer and the metal hydroxide in a continuous phase comprising the thermoplastic polyurethane and the metal hydroxide.

9. The method of claim 8, in which the polar olefin polymer is an ethylene vinyl acetate polymer and the peroxide crosslinking agent has a decomposition temperature of at least 140° C.

10. The method of claim 8, further comprising adding an epoxidized novolac resin to the first resin composition.
